(19) United States
(12) Patent Application Publication
(10) Pub. No.: US 2005/0026786 A1
(43) Pub. Date: Feb. 3, 2005

(54) Oil suspension concentrate

(75) Inventors: Roland Deckwer, Frankfurt Am Main (DE); Detlev Haase, Frankfurt (DE); Hans-Peter Krause, Hofheim (DE); Gerhard Schnabel, Elsenfeld (DE)

Correspondence Address: CONNOLLY BOVE LODGE & HUTZ, LLP, P O BOX 2207, WILMINGTON, DE, 19899, US

(73) Assignee: Bayer CropScience GmbH, Frankfurt am Main (DE)

(21) Appl. No.: 10/900,848

(22) Filed: Jul. 28, 2004

(30) Foreign Application Priority Data
Jul. 28, 2003 (DE) DE 10334300.8

(51) Int. Cl. A01N 47/36; A01N 43/653; A01N 25/04; A01N 25/16

(52) U.S. Cl. 504/211; 504/272; 504/364

(57) ABSTRACT

The present invention relates to an oil suspension concentrate, comprisinga) the herbicidally active compound diflufenican, and b) one or more solvents from the group of the hydrocarbons. The oil suspension concentrate is suitable for use in crop protection.

The present invention relates to the field of formulations of crop protection agents. In particular, the invention relates to liquid formulations in the form of oil suspension concentrates comprising the herbicidally active compound diflufenican.

In general, active compounds for crop protection are not employed in pure form. Depending on the area of use and the type of use, and on physical, chemical and biological parameters, the active compound is used as an active compound formulation in a mixture with customary auxiliaries and additives. Also known are combinations with further active compounds for widening the activity spectrum and/or for protecting crop plants (for example by safeners, antidotes).

In general, formulations of active compounds for crop protection should have high chemical and physical stability, should be easy to apply and easy to use and have broad biological action combined with high selectivity.

It was an object of the present invention to provide an improved formulation of crop protection agents, which formulation is easy to apply and has high biological effectiveness and crop plant compatibility.

This object is achieved by the specific oil suspension concentrate of the present invention.

Accordingly, the present invention relates to an oil suspension concentrate comprising
a) the herbicidally active compound diflufenican, and
b) one or more solvents from the group of the hydrocarbons.

In addition, the oil suspension concentrate according to the invention may optionally also comprise further components, for example:
c) one or more herbicidally active compounds from the group of the ALS inhibitors,
d) one or more safeners,
e) one or more agrochemically active compounds different from a), c) and d),
f) one or more sulfosuccinates, and/or
g) customary auxiliaries and additives.

For the purpose of the present invention, the term “oil suspension concentrate” (OD) is to be understood as meaning a suspension concentrate based on component b) (hydrocarbons). Here, one or more active compounds are suspended in the hydrocarbons, further active compounds may be dissolved in the hydrocarbons.

In the oil suspension concentrate according to the invention, the herbicidally active compound diflufenican a) is present in suspended form in the hydrocarbons b). This means that the major portion (in % by weight) of diflufenican is present undissolved in finely distributed form, a minor portion of the diflufenican may be dissolved. Preferably, more than 80% by weight, particularly preferably more than 90% by weight, of the diflufenican is suspended in the hydrocarbons b), in each case based on the total amount of diflufenican in the oil suspension concentrate according to the invention.

The herbicidally active compound diflufenican contained as component a) is known and commercially available (see, for example, “The Pesticide Manual” 12th edition (2000), The British Crop Protection Council, pages 296-297). In the oil suspension concentrate according to the invention, diflufenican is generally present in a proportion of from 1 to 60% by weight, preferably from 2.5 to 30% by weight; here and in the entire description, the term “% by weight” refers, unless defined otherwise, to the relative weight of the component in question, based on the total weight of the formulation.

The oil suspension concentrate according to the invention comprises, as component b), one or more hydrocarbons (see, for example, Römpp Lexikon Chemie, 10th edition, volume 3, page 2202 (1997), Georg Thieme Verlag Stuttgart/New York), preferably those which are liquid under STP conditions. The hdrocarbons can be acyclic (aliphatic) hydrocarbons or cyclic hydrocarbons, for example aromatic or alicyclic (cycloaliphatic) hydrocarbons.

Examples of hydrocarbons b) are:
1) aromatic hydrocarbons, for example
   mono- or polyalkyl-substituted (for example mono-, di- or tri-(C₁-C₁₀)-alkyl-substituted) aromatic hydrocarbons, for example benzenes, such as toluene, xylenes, mesitylene, ethylbenzene, or
   hydrocarbons having fused aromatic ring systems, such as naphthalenes, for example 1-methylnaphthalene, 2-methylnaphthalene or dimethylnaphtalene, or other fused aromatic hydrocarbons, such as indane or tetralin,
2) cycloaliphatic hydrocarbons, for example
   saturated or unsaturated, optionally mono- or polyalkyl-substituted (for example mono-, di- or tri-(C₁-C₁₀)-alkyl-substituted) cycloaliphatic hydrocarbons, such as cycloalkanes, cycloalkenes or cycloalkynes, for example cyclohexane or methylcyclopentane,
3) aliphatic hydrocarbons, for example
   straight-chain or branched, saturated or unsaturated aliphatic hydrocarbons, preferably C₅-C₁₆-aliphatic hydrocarbons, for example alkanes, alkenes or alkynes, such as pentane, hexane, octane, 2-methylbutane or 2,2,4-trimethylpentane.

The oil suspension concentrate may also comprise, as component b), mixtures of one or more aromatic hydrocarbons and/or one or more cycloaliphatic hydrocarbons and/or one or more aliphatic hydrocarbons. Examples are mixtures of a plurality of aliphatic hydrocarbons, for example commercially available solvents of the ExxsoL®D series, the ISOPAR® series or the BAYOL® series, for example Bayol®82 (EXXONMOBIL CHEMICALS), or of the ISANE®IP series or HDROSEAL®G series (TOTALFINAELF), or mixtures of aromatic and aliphatic hydrocarbons, for example commercially available solvents of the SOLVESSO® series, for example Solvesso®100, Solvesso®150 or Solvesso®200 (EXXONMOBIL CHEMICALS), of the SOLVAREX®/SOLVARO® series (TOTALFINAELF) or of the Caromax® series, for example Caromax®28 (Petrochem Carless).

Preferred components b) are aliphatic hydrocarbons, in particular saturated aliphatic hydrocarbons, for example C₅-C₁₆-alkanes, for example from the Bayol® series. The total proportion of hydrocarbons b) in the oil suspension concentrates according to the invention is generally between 5 and 95% by weight, preferably in the range from 10 to 90% by weight.

Suitable ALS inhibitors c) are, for example, compounds from the group of the imidazolinones, pyrimidinyloxypyridinecarboxylic acid derivatives, pyrimidyloxybenzoic acid derivatives or sulfonamides, such as triazolopyrimidinesulfonamides or sulfonylaminocarbonyltriazolinones, preferably phenylsulfonylaminocarbonyltriazolinones, for example flucarbazone or propoxycarbazone and/or salts thereof, or sulfonylureas, preferably phenylsulfonylureas.

Preferred ALS inhibitors originate from the group of the sulfonylureas, for example pyrimidinyl- or triazinylaminocarbonyl[benzene-, -pyridine-, -pyrazole-, -thiophene- and -(alkylsulfonyl)alkylamino]sulfamides. Preferred substituents on the pyrimidine ring or the triazine ring are alkoxy, alkyl, haloalkoxy, haloalkyl, halogen or dimethylamino, it being possible to combine all substituents independently of one another. Preferred substituents in the benzene, pyridine, pyrazole, thiophene or (alkylsulfonyl)alkylamino moiety are alkyl, alkoxy, halogen, such as F, Cl, Br or I, amino, alkylamino, dialkylamino, acylamino, such as formylamino, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, alkylsulfonylaminoalkyl, (alkanesulfonyl)alkylamino. Such suitable sulfonylureas are, for example,

A1) phenyl- and benzylsulfonylureas and related compounds, for example

1-(2-chlorophenylsulfonyl)-3-(4-methoxy-6-methyl-1,3,5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1,3,5-triazin-2-yl)urea (metsulfuron-methyl),
1-(2-chloroethoxyphenylsulfonyl)-3-(4-methoxy-6-methyl-1,3,5-triazin-2-yl)urea (triasulfuron),
1-(2-methoxycarbonylphenylsulfonyl)-3-(4,6-dimethylpyrimidin-2-yl)urea (sulfumeturon-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonylbenzylsulfonyl)-3-(4,6-dimethoxypyrimidin-2-yl)urea (bensulfuron-methyl),
1-(2-methoxycarbonylphenylsulfonyl)-3-(4,6-bis-(difluoromethoxy)pyrimidin-2-yl)urea (primisulfuron-methyl),
3-(4-ethyl-6-methoxy-1,3,5-triazin-2-yl)-1-(2,3-dihydro-1,1-dioxo-2-methylbenzo-[b]thiophene-7-sulfonyl)urea (EP-A 0 796 83),
3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),
3-(4-methoxy-6-methyl-1,3,5-triazin-2-yl)-1-(2-methoxycarbonyl-5-iodophenylsulfonyl)urea (iodosulfuron-methyl and its salts, such as the sodium salt, WO 92/13845),
DPX-66037, triflusulfuron-methyl (see Brighton Crop Prot. Conf.—Weeds—1995, p. 853),
CGA-277476, (see Brighton Crop Prot. Conf.—Weeds—1995, p. 79), methyl 2-[3-(4,6-dimethoxypyrimidin-2-yl)ureidosulfonyl]-4-methanesulfonamidomethylbenzoate (mesosulfuron-methyl and its salts, such as the sodium salt, WO 95/10507),
N,N-dimethyl-2-[3-(4,6-dimethoxypyrimidin-2-yl)ureidosulfonyl]-4-formylaminobenzamide (foramsulfuron and its salts, such as the sodium salt, WO 95/01344);
   A2) thienylsulfonylureas, for example
1-(2-methoxycarbonylthiophen-3-yl)-3-(4-methoxy-6-methyl-1,3,5-triazin-2-yl)urea (thifensulfuron-methyl);
   A3) pyrazolylsulfonylureas, for example
1-(4-ethoxycarbonyl-1-methylpyrazol-5-ylsulfonyl)-3-(4,6-dimethoxypyrimidin-2-yl)urea (pyrazosulfuron-methyl);
methyl 3-chloro-5-(4,6-dimethoxypyrimidin-2-ylcarbamoylsulfamoyl)-1-methylpyrazole-4-carboxylate (EP-A 0 282 613);
methyl 5-(4,6-dimethylpyrimidin-2-ylcarbamoylsulfamoyl)-1-(2-pyridyl)pyrazole-4-carboxylate (NC-330, see Brighton Crop Prot. Conference ‘Weeds’ 1991, Vol. 1, p. 45 ff.),
DPX-A8947, azimsulfuron, (see Brighton Crop Prot. Conf. ‘Weeds’ 1995, p. 65);
   A4) sulfonediamide derivatives, for example
3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, special issue XII, 489-497 (1990));
   A5) pyridylsulfonylureas, for example
1-(3-N,N-dimethylaminocarbonylpyridin-2-ylsulfonyl)-3-(4,6-dimethoxypyrimidin-2-yl)urea (nicosulfuron),
1-(3-ethylsulfonylpyridin-2-ylsulfonyl)-3-(4,6-dimethoxypyrimidin-2-yl)urea (rimsulfuron),
methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron, see Brighton Crop Prot. Conf. Weeds, 1995, p. 49),
pyridylsulfonylureas as described, for example, in DE-A 40 00 503 and DE-A 40 30 577, preferably those of the formula 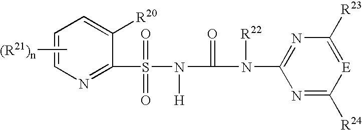
in which
E is CH or N, preferably CH,
R²⁰ is iodine or NR²⁵R²⁶,
R²¹ is hydrogen, halogen, cyano, (C₁-C₃)-alkyl, (C₁-C₃)-alkoxy, (C₁-C₃)-haloalkyl, (C₁-C₃)-haloalkoxy, (C₁-C₃)-alkylthio, (C₁-C₃)-alkoxy-(C₁-C₃)-alkyl, (C₁-C₃)-alkoxy-carbonyl, mono- or di-((C₁-C₃)-alkyl)amino, (C₁-C₃)-alkylsulfinyl or -sulfonyl, SO₂—NR^{x}R^{y} or CO—NR^{x}R^{y}, in particular hydrogen,
R^{x}, R^{y} independently of one another are hydrogen, (C₁-C₃)-alkyl, (C₁-C₃)-alkenyl, (C₁-C₃)-alkynyl or together are —(CH₂)₄—, —(CH₂)₅— or —(CH₂)₂—O—(CH₂)₂—,
n is 0, 1, 2 or 3, preferably 0 or 1,
R²² is hydrogen or CH₃,
R²³ is halogen, (C₁-C₂)-alkyl, (C₁-C₂)-alkoxy, (C₁-C₂)-haloalkyl, in particular CF₃, (C₁-C₂)-haloalkoxy, preferably OCHF₂ or OCH₂CF₃,
R²⁴ is (C₁-C₂)-alkyl, (C₁-C₂)-haloalkoxy, preferably OCHF₂, or (C₁-C₂)-alkoxy,
R²⁵ is (C₁-C₄)-alkyl,
R²⁶ is (C₁-C₄)-alkylsulfonyl or
R²⁵ and R²⁶ together are a chain of the formula —(CH₂)₃SO₂— or —(CH₂)₄SO₂—, for example 3-(4,6-dimethoxypyrimidin-2-yl)-1-(3-N-methylsulfonyl-N-methylaminopyridin-2-yl)sulfonylurea, or salts thereof;
   A6) alkoxyphenoxysulfonylureas as described, for example, in EP-A 0 342 569, preferably those of the formula 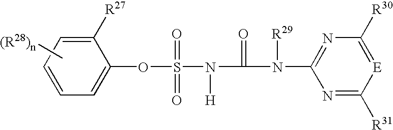
in which
E is CH or N, preferably CH,
R²⁷ is ethoxy, propoxy or isopropoxy,
R²⁸ is halogen, NO₂, CF₃, CN, (C₁-C₄)-alkyl, (C₁-C₄)-alkoxy, (C₁-C₄)-alkylthio or (C₁-C₃)-alkoxy-carbonyl, preferably in the 6-position on the phenyl ring,
n is 0, 1, 2 or 3, preferably 0 or 1,
R²⁹ is hydrogen, (C₁-C₄)-alkyl or (C₃-C₄)-alkenyl,
R³⁰, R³¹ independently of one another are halogen, (C₁-C₂)-alkyl, (C₁-C₂)-alkoxy, (C₁-C₂)-haloalkyl, (C₁-C₂)-haloalkoxy or (C₁-C₂)-alkoxy-(C₁-C₂)-alkyl, preferably OCH₃ or CH₃, for example 3-(4,6-dimethoxypyrimidin-2-yl)-1-(2-ethoxyphenoxy)sulfonylurea or salts thereof;
   A7) imidazolylsulfonylureas, for example
MON 37500, sulfosulfuron (see Brighton Crop Prot. Conf. ‘Weeds’, 1995, p. 57), and other related sulfonylurea derivatives and mixtures thereof.

Typical representatives of these active compounds are, inter alia, the compounds listed below: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, iodosulfuron-methyl and its sodium salt (WO 92/13845), mesosulfuron-methyl and its sodium salt (Agrow No. 347, Mar. 3, 2000, page 22 (PJB Publications Ltd. 2000)) and foramsulfuron and its sodium salt (Agrow No. 338, Oct. 15, 1999, page 26 (PJB Publications Ltd. 1999)).

The active compounds listed above are known, for example from “The Pesticide Manual”, 12th edition (2000), The British Crop Protection Council, or from the literature references following the individual active compounds.

Other suitable ALS inhibitors are, for example,

B) imidazolinones, for example

methyl 2-(4-isopropyl-4-methyl-5-oxo-2-imidazolin-2-yl)-5-methylbenzoate and 2-(4-isopropyl -4-methyl-5-oxo-2-imidazolin-2-yl)-4-methylbenzoic acid (imazamethabenz), 5-ethyl-2-(4-isopropyl-4-methyl-5-oxo-2-imidazolin-2-yl)pyridine-3-carboxylic acid (imazethapyr),
2-(4-isopropyl-4-methyl-5-oxo-2-imidazolin-2-yl)quinoline-3-carboxylic acid (imazaquin),
2-(4-isopropyl-4-methyl-5-oxo-2-imidazolin-2-yl)pyridine-3-carboxylic acid (imazapyr),
5-methyl-2-(4-isopropyl-4-methyl-5-oxo-2-imidazolin-2-yl)pyridine-3-carboxylic acid (imazethamethapyr);
   C) triazolopyrimidinesulfonamides, for example
N-(2,6-difluorophenyl)-7-methyl-1,2,4-triazolo[1,5-c]pyrimidine-2-sulfonamide (flumetsulam),
N-(2,6-dichloro-3-methylphenyl)-5,7-dimethoxy-1,2,4-triazolo[1,5-c]pyrimidine-2-sulfonamide,
N-(2,6-difluorophenyl)-7-fluoro-5-methoxy-1,2,4-triazolo[1,5-c]pyrimidine-2-sulfonamide,
N-(2,6-dichloro-3-methylphenyl)-7-chloro-5-methoxy-1,2,4-triazolo[1,5-c]pyrimidine-2-sulfonamide,
N-(2-chloro-6-methoxycarbonyl)-5,7-dimethyl-1,2,4-triazolo[1,5-c]pyrimidine-2-sulfonamide (EP-A 0 343 752, U.S. Pat. No. 4,988,812);
   D) pyrimidinyloxypyridinecarboxylic acid or pyrimidinyloxybenzoic acid derivatives, for example
benzyl 3-(4,6-dimethoxypyrimidin-2-yl)oxypyridine-2-carboxylate (EP-A 0 249 707),
methyl 3-(4,6-dimethoxypyrimidin-2-yl)oxypyridine-2-carboxylate (EP-A 0 249 707),
2,6-bis[(4,6-dimethoxypyrimidin-2-yl)oxy]benzoic acid (EP-A 0 321 846),
1-(ethoxycarbonyloxyethyl) 2,6-bis[(4,6-dimethoxypyrimidin-2-yl)oxy]benzoate (EP-A 0 472 113).

Suitable sulfonamides are preferably sulfonamides of the formula (I) and/or salts thereof
R^{α}-(A)ₘ-SO₂—NR^{β}—CO—(NR^{γ})ₙ—R^{δ} (I)
in which
R^{α} is a hydrocarbon radical, preferably an aryl radical, such as phenyl, which is unsubstituted or substituted, or a heterocyclic radical, preferably a heteroaryl radical, such as pyridyl, which is unsubstituted or substituted, where the radicals including substituents have 1-30 carbon atoms, preferably 1-20 carbon atoms, or R^{α} is an electron-withdrawing group, such as a sulfonamide radical,
R^{β} is a hydrogen atom or a hydrocarbon radical which is unsubstituted or substituted and, including substituents, has 1-10 carbon atoms, for example unsubstituted or substituted C₁-C₆-alkyl, preferably a hydrogen atom or methyl,
R⁶⁵ is a hydrogen atom or a hydrocarbon radical which is unsubstituted or substituted and, including substituents, has 1-10 carbon atoms, for example unsubstituted or substituted C₁-C₆-alkyl, preferably a hydrogen atom or methyl,
A is CH₂, O or NH, preferably O,
m is zero or 1,
n is zero or 1, preferably 1, and
R^{δ} is a heterocyclic radical, such as a pyridyl radical, a triazinyl radical or a triazolinone radical.

Examples of sulfonamides of the formula (I) are sulfonylureas of the formula (II) and/or salts thereof 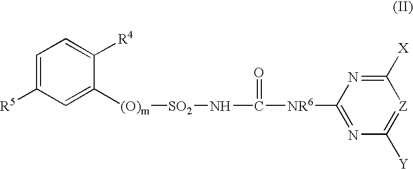
in which
R⁴ is C₁-C₄-alkoxy, preferably C₂-C₄-alkoxy, or CO—R^{a}, where R^{a} is OH, C₁-C₄-alkoxy or NR^{b}R^{c}, where R^{b} and R^{c} independently of one another are identical or different radicals H or C₁-C₄-alkyl,
R⁵ is halogen, preferably iodine, or (A)ₙ-NR^{d}R^{e}, where n is zero or 1, A is a group CR′R″, where R′ and R″ independently of one another are identical or different radicals H or C₁-C₄-alkyl, R^{d} is H or C₁-C₄-alkyl and R^{e} is an acyl radical, such as formyl, or C₁-C₄-alkylsulfonyl, and, if R⁴ is C₁-C₄-alkoxy, preferably C₂-C₄-alkoxy, R⁵ may also be H,
R⁶ is H or C₁-C₄-alkyl,
m is zero or 1,
X and Y independently of one another are identical or different radicals C₁-C₆-alkyl, C₁-C₆-alkoxy or C₁-C₆-alkylthio, where each of the three radicals mentioned is unsubstituted or substituted by one or more radicals from the group consisting of halogen, C₁-C₄-alkoxy and C₁-C₄-alkylthio, or are C₃-C₆-cycloalkyl, C₂-C₆-alkenyl, C₂-C₆-alkynyl, C₃-C₆-alkenyloxy or C₃-C₆-alkynyloxy, preferably C₁-C₄-alkyl or C₁-C₄-alkoxy, and
Z is CH or N.

Preference is given to sulfonylureas of the formula (II) and/or salts thereof in which
a) R⁴ is CO—(C₁-C₄-alkoxy), R⁵ is halogen, preferably iodine, or R⁵ is CH₂—NHR^{e}, where R^{e} is an acyl radical, preferably C₁-C₄-alkylsulfonyl, and m is zero,
b) R⁴ is CO—N(C₁-C₄-alkyl)₂, R⁵ is NHR^{e}, where R^{e} is an acyl radical, preferably formyl, and m is zero, or
c) R⁴ is C₂-C₄-alkoxy, R⁵ is H and m is 1.

Particularly preferred ALS inhibitors are: iodosulfuron-methyl (A1) and its sodium salt (A2), mesosulfuron-methyl (A3) and its sodium salt (A4), foramsulfuron (A5) and its sodium salt (A6), flucarbazone (A7) and its sodium salt (A8), propoxycarbazone (A9) and its sodium salt (A10), ethoxysulfuron (A11) and its sodium salt (A 12), and amidosulfuron (A 13) and its sodium salt (A 14).

The active compounds listed above are known, for example from “The Pesticide Manual”, 13th edition (2003), The British Crop Protection Council, or from the literature references given after the individual active compounds.

If the oil suspension concentrates according to the invention comprise, as component c), ALS inhibitors, for example the sulfonamides mentioned above, such as sulfonamides of the formula (I) and/or salts thereof, these can be present in suspended form and/or in dissolved form.

If the oil suspension concentrates according to the invention contain herbicidally active compounds from the group of the ALS inhibitors, their proportion by weight is generally from 0.01 to 50% by weight, preferably from 0.1 to 30% by weight.

Whenever the term “acyl radical” is used in this description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbamic acids, sulfonic acids, sulfinic acids, phosphonic acids, phosphinic acids.

An acyl radical is preferably formyl or acyl from the group consisting of CO—R^{z}, CS—R^{z}, CO—OR^{z}, CS—OR^{z}, CS—SR^{z}, SOR^{z} and SO₂R^{z}, where R^{z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br or I, alkoxy, haloalkoxy, hydroxyl, amino, nitro, cyano and alkylthio, or R^{z} is aminocarbonyl or aminosulfonyl, where the two lastmentioned radicals are unsubstituted, N-monosubstituted or N,N-disubstituted, for example by substituents from the group consisting of alkyl and aryl.

Acyl is, for example, formyl, haloalkylcarbonyl, alkylcarbonyl, such as (C₁-C₄)-alkyl-carbonyl, phenylcarbonyl, where the phenyl ring may be substituted, or alkyloxy-carbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

An aromatic radical (aryl) is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo, for example in the triazolinone radical. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Unsubstituted or substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio and the corresponding unsaturated and/or substituted radicals may in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl; alkynyl is, for example, propargyl, but-2-yn-1-yl, but-3-yn-1-yl, 1-methylbut-3-yn-1-yl.

Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

Within the context of the present invention, the ALS inhibitors contained as component c) in the oil suspension concentrates according to the invention are in each case to be understood as including, in addition to the neutral compounds, also their salts with inorganic and/or organic counterions. Thus, sulfonamides, for example, are capable of forming salts in which the hydrogen of the —SO₂—NH— group is replaced by an agriculturally suitable cation. These salts are, for example, metal salts, in particular alkali metal salts or alkaline earth metal salts, especially sodium and potassium salts, or else ammonium salts or salts with organic amines. Salt formation may also occur by an acid forming an adduct with basic groups, such as, for example, amino and alkylamino. Acids suitable for this purpose are strong inorganic and organic acids, for example HCI, HBr, H₂SO₄ or HNO₃.

The oil suspension concentrates according to the invention may comprise, as optional component d), safeners which are suitable for reducing or preventing damage to the crop plant. Suitable safeners are known, for example, from WO-A-96/14747 and the literature cited therein.

Suitable safeners are, for example, the following groups of compounds:
1) Compounds of the type of dichlorophenylpyrazoline-3-carboxylic acid (S1), preferably compounds such as ethyl 1-(2,4-dichlorophenyl)-5-(ethoxy-carbonyl)-5-methyl-2-pyrazoline-3-carboxylate (S1-1, mefenpyr-diethyl, PM pp. 781-782), and related compounds, as described in WO 91/07874.
2) Derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806.
3) Compounds of the type of the triazolecarboxylic acids (S1), preferably compounds such as fenchlorazole, i.e. ethyl 1-(2,4-dichlorophenyl)-5-trichloro-methyl-(1H)-1,2,4-triazole-3-carboxylate (S1-6), and related compounds (see EP-A-174 562 and EP-A-346 620).
4) Compounds of the type of the 5-benzyl- or 5-phenyl-2-isoxazoline-3-carboxylic acid, or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or 5,5-diphenyl-2-isoxazolinecarboxylic acid and its ethyl ester (S1-9, isoxadifen-ethyl) or n-propyl ester (S1-10) or ethyl 5-(4-fluorophenyl)-5-phenyl-2-isoxazoline-3-carboxylate (S1)-11), as described in the patent application (WO-A-95/07897).
5) Compounds of the type of the 8-quinolineoxyacetic acid (S2), preferably 1-methylhex-1-yl (5-chloro-8-quinolineoxy)acetate (S2-1, cloquintocet-mexyl, PM pp. 263-264), 1,3-dimethylbut-1-yl (5-chloro-8-quinolineoxy)acetate (S2-2), 4-allyloxybutyl (5-chloro-8-quinolineoxy)acetate (S2-3), 1-allyloxyprop-2-yl (5-chloro-8-quinolineoxy)acetate (S2-4), ethyl (5-chloro-8-quinolineoxy)acetate (S2-5), methyl (5-chloro-8-quinolineoxy)acetate (S2-6), allyl (5-chloro-8-quinolineoxy)acetate (S2-7), 2-(2-propylideneiminooxy)-1-ethyl (5-chloro-8-quinolineoxy)acetate (S2-8), 2-oxoprop-1-yl (5-chloro-8-quinolineoxy)acetate (S2-9) and related compounds, as described in EP-A-86 750, EP-A-94 349 and EP-A-191 736 or EP-A-0 492 366.
6) Compounds of the type of the (5-chloro-8-quinolineoxy)malonic acid, preferably compounds such as diethyl (5-chloro-8-quinolineoxy)malonate, diallyl (5-chloro-8-quinolineoxy)malonate, methylethyl (5-chloro-8-quinoline-oxy)malonate and related compounds, as described in EP-A-0 582 198.
7) Active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxy-propionic esters (mecoprop), MCPA or 3,6-dichloro-2-methoxybenzoic acid (esters) (dicamba).
8) Active compounds of the type of the pyrimidines, such as “fenclorim” (PM, pp. 512-511) (=4,6-dichloro-2-phenylpyrimidine).
9) Active compounds of the type of the dichloroacetamides, which are frequently used as pre-emergence safeners (soil-acting safeners), such as, for example, “dichlormid” (PM, pp. 363-364 (=N,N-diallyl-2,2-dichloroacetamide), “R-29148” (=3-dichloroacetyl-2,2,5-trimethyl-1,3-oxazolidone from Stauffer), “benoxacor” (PM, pp.102-103) (=4-dichloroacetyl-3,4-dihydro-3-methyl-2H-1,4-benzoxazine), “PPG-1292” (=N-allyl-N-[(1,3-dioxolan-2-yl)methyl]dichloroacetamide from PPG Industries), “DK-24” (=N-allyl-N-[(allylaminocarbonyl)methyl]dichloroacetamide from Sagro-Chem), “AD-67” or “MON 4660” (=3-dichloroacetyl-1-oxa-3-azaspiro[4,5]decane from Nitrokemia or Monsanto), “diclonon” or “BAS145138” or “LAB145138” (=3-dichloroacetyl-2,5,5-tri-methyl-1,3-diazabicyclo[4.3.0]nonane from BASF) and “furilazol” or “MON 13900” (see PM, 637-638) (=(RS)-3-dichloroacetyl-5-(2-furyl)-2,2-dimethyloxazolidone).
10) Active compounds of the type of the dichloroacetone derivatives, such as, for example, “MG 191” (CAS-Reg. No. 96420-72-3) (=2-dichloromethyl-2-methyl-1,3-dioxolane from Nitrokemia).
11) Active compounds of the type of the oxyimino compounds, which are known as seed dressings, such as, for example, “oxabetrinil” (PM, pp. 902-903) (=(Z)-1,3-dioxolan-2-ylmethoxyimino-(phenyl)acetonitrile), which is known as seed dressing safener against metolachlor damage, “fluxofenim” (PM, pp. 613-614) (=1-(4-chlorophenyl)-2,2,2-trifluoro-1-ethanone O-(1,3-dioxolan-2-ylmethyl) oxime which is known as seed dressing safener against metolachlor damage, and “cyometrinil” or “CGA-43089” (PM, p.1304) (=(Z)-cyanomethoxyimino-(phenyl)acetonitrile), which is known as seed dressing safener against metolachlor damage.
12) Active compounds of the type of the thiazolecarboxylic esters, which are known as seed dressings, such as, for example, “flurazole” (PM, pp. 590-591) (=benzyl 2-chloro-4-trifluoromethyl-1,3-thiazole-5-carboxylate), which is known as seed dressing safener against alachlor and metolachlor damage.
13) Active compounds of the type of the naphthalenedicarboxylic acid derivatives, which are known as seed dressings, such as, for example, “naphthalic anhydride” (PM, p. 1342) (=1,8-naphthalenedicarboxylic anhydride), which is known as seed dressing safener for corn against thiocarbamate herbicide damage.
14) Active compounds of the type of the chromanacetic acid derivatives, such as, for example, “CL 304415” (CAS-Reg. No. 31541-57-8) (=2-(4-carboxychroman-4-yl)acetic acid from American Cyanamid).

15) Active compounds which, in addition to a herbicidal action against harmful plants, also have safener action on crop plants such as, for example, “dimepiperate” or “MY-93” (PM, pp. 404-405) (=S-1-methyl-1-phenylethyl piperidine-1-thiocarboxylate), “daimuron” or “SK 23” (PM, p. 330) (=1-(1-methyl-1-phenylethyl)-3-p-tolyl-urea), “cumyluron”=“JC-940” (=3-(2-chlorophenyl methyl)- 1-(1-methyl-1-phenyl-ethyl)urea, see JP-A-60087254), “methoxyphenone” or “NK 049” (=3,3′-dimethyl4-methoxybenzophenone), “CSB” (=1-bromo-4-(chloromethylsulfonyl)benzene) (CAS-Reg. No. 54091-06-4 from Kumiai), compounds of the type of the acylsulfamoylbenzamides, for example of formula (VIII) below, which are known, for example, from WO 99/16744.

(VIII)

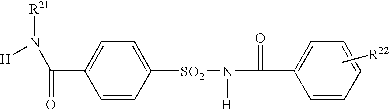

| Compound No. | R²¹ | R²² |
|---|---|---|
| S3-1 | cyclopropyl | 2-OCH₃ |
| S3-2 | cyclopropyl | 2-OCH₃, 5-Cl |
| S3-3 | ethyl | 2-OCH₃ |
| S3-4 | isopropyl | 2-OCH₃, 5-Cl |
| S3-5 | isopropyl | 2-OCH₃ |

Preferred safeners are mefenpyr, fenchlorazole, isoxadifen, cloquintocet, and their C₁-C₁₀-alkyl esters, and also the safeners (S3-1), (S3-5) and benoxacor (S-4), in particular mefenpyr-diethyl (S1-1), fenchlorazole-ethyl (S1-6), isoxadifen-ethyl ((S1)-9), cloquintocet-mexyl (S2-1), (S3-1), (S3-5) and benoxacor (S-4).

If the oil suspension concentrates according to the invention comprise safeners d), their proportion by weight is generally 0.1 to 60% by weight, in particular 0.5 to 40% by weight. The safeners can be present in suspended form and/or in dissolved form.

Possible agrochemically active compounds e), which may optionally be present, are, for example, agrochemically active compounds different from components a), c) and d), such as herbicides, fungicides, insecticides, plant growth regulators and the like. The agrochemically active compounds e) may be present in the hydrocarbon b) in suspended form and/or in dissolved form.

Suitable active compounds different from components a), c) and d), which active compounds may be present in the oil suspension concentrates according to the invention as component e), are, preferably, herbicidally active compounds, for example from the group of the carbamates, thiocarbamates, haloacetanilides, substituted phenoxy-, naphthoxy- and phenoxyphenoxycarboxylic acid derivatives, and also heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic acid esters, cyclohexanedione derivatives, phosphorus-containing herbicides, for example of the glufosinate type or of the glyphosate type, and also S-(N-aryl-N-alkylcarbamoylmethyl)dithiophosphoric acid esters. Preference is given here to phenoxyphenoxy- and heteroaryloxyphenoxycarboxylic acid esters and salts, such as fenoxaprop, and also to herbicides such as bentazone, cyanazine, atrazine, diflufenican, dicamba, 2,4-D, or hydroxybenzonitriles, such as bromoxynil and ioxynil, and other foliar herbicides, for example:

E) herbicides of the type of the phenoxyphenoxy- and heteroaryloxyphenoxycarboxylic acid derivatives, such as

E1) phenoxyphenoxy- and benzyloxyphenoxycarboxylic acid derivatives, for example methyl 2-(4-(2,4-dichlorophenoxy)phenoxy)propionate (diclofop-methyl), methyl 2-(4-(4-bromo-2-chlorophenoxy)phenoxy)propionate (DE-A 26 01 548), methyl 2-(4-(4-bromo-2-fluorophenoxy)phenoxy)propionate (U.S. Pat No. 4,808,750), methyl 2-(4-(2-chloro-4-trifluoromethylphenoxy)phenoxy)propionate (DE-A 24 33 067), methyl 2-(4-(2-fluoro-4-trifluoromethylphenoxy)phenoxy)propionate (U.S. Pat. No. 4,808,750), methyl 2-(4-(2,4-dichlorobenzyl)phenoxy)propionate (DE-A 24 17 487), ethyl 4-(4-(4-trifluoromethylphenoxy)phenoxy)pent-2-enoate, methyl 2-(4-(4-trifluoromethylphenoxy)phenoxy)propionate (DE-A 24 33 067);

E2) “monocyclic” heteroaryloxyphenoxyalkanecarboxylic acid derivatives, for example

ethyl 2-(4-(3,5-dichloropyridyl-2-oxy)phenoxy)propionate (EP-A 0 002 925), propargyl 2-(4-(3,5-dichloropyridyl-2-oxy)phenoxy)propionate (EP-A 0 003 114),
methyl 2-(4-(3-chloro-5-trifluoromethyl-2-pyridyloxy)phenoxy)propionate (EP-A 0 003 890),
ethyl 2-(4-(3-chloro-5-trifluoromethyl-2-pyridyloxy)phenoxy)propionate (EP-A 0 003 890),
propargyl 2-(4-(5-chloro-3-fluoro-2-pyridyloxy)phenoxy)propionate (EP-A 0 191 736),
butyl 2-(4-(5-trifluoromethyl-2-pyridyloxy)phenoxy)propionate (fluazifop-butyl);
   E3) “bicyclic” heteroaryloxyphenoxyalkanecarboxylic acid derivatives, for example
methyl and ethyl 2-(4-(6-chloro-2-quinoxalyloxy)phenoxy)propionate (quizalofopmethyl and quizalofopethyl),
methyl 2-(4-(6-fluoro-2-quinoxalyloxy)phenoxy)propionate (see J. Pest. Sci. Vol. 10, 61 (1985)),
2-isopropylideneaminooxyethyl 2-(4-(6-chloro-2-quinoxalyloxy)phenoxy)propionate (propaquizafop),
ethyl 2-(4-(6-chlorobenzothiazol-2-yloxy)phenoxy)propionate (DE-A 26 40 730), tetrahydro-2-furylmethyl 2-(4-(6-chloroquinoxalyloxy)phenoxy)propionate (EP-A 0 323 727);
   F) chloroacetanilides, for example
N-methoxymethyl-2,6-diethylchloroacetanilide (alachlor),
N-(3-methoxyprop-2-yl)-2-methyl-6-ethylchloroacetanilide (metolachlor),
2,6-dimethyl-N-(3-methyl-1,2,4-oxadiazol-5-ylmethyl)chloroacetanilide,
N-(2,6-dimethylphenyl)-N-(1-pyrazolylmethyl)chloroacetamide (metazachlor);
   G) thiocarbamates, for example
S-ethyl N,N-dipropylthiocarbamate (EPTC),
S-ethyl N,N-diisobutylthiocarbamate (butylate);
   H) cyclohexanedione oximes, for example
methyl 3-(1-allyloxyiminobutyl)-4-hydroxy-6,6-dimethyl-2-oxocyclohex-3-ene-carboxylate (alloxydim),
2-(1-ethoxyiminobutyl)-5-(2-ethylthiopropyl)-3-hydroxycyclohex-2-ene-1-one (sethoxydim),
2-(1-ethoxyiminobutyl)-5-(2-phenylthiopropyl)-3-hydroxycyclohex-2-ene-1-one (cloproxydim),
2-(1-(3-chloroallyloxy)iminobutyl)-5-(2-ethylthiopropyl)-3-hydroxycyclohex-2-ene-1-one,
2-(1-(3-chloroallyloxy)iminopropyl)-5-(2-ethylthiopropyl)-3-hydroxycyclohex-2-ene-1-one (clethodim),
2-(1-ethoxyiminobutyl)-3-hydroxy-5-(thian-3-yl)cyclohex-2-enone (cycloxydim),
2-(1-ethoxyiminopropyl)-5-(2,4,6-trimethylphenyl)-3-hydroxycyclohex-2-ene-1-one (tralkoxydim);
   I) benzoylcyclohexanediones, for example
2-(2-chloro4-methylsulfonylbenzoyl)cyclohexane-1,3-dione (SC-0051, EP-A 0 137 963, sylcotrione), 2-(2-nitrobenzoyl)4,4-dimethylcyclohexane-1,3-dione (EP-A 0 274 634),
2-(2-nitro-4-methylsulfonyl benzoyl )4,4-dimethylcyclohexane-1,3-dione (WO 91/13548, mesotrione);
   J) S-(N-aryl-N-alkylcarbamoylmethyl) dithiophosphonates, such as
S-[N-(4-chlorophenyl)-N-isopropylcarbamoylmethyl] O,O-dimethyl dithiophosphate (anilophos);
K) alkylazines, such as, for example, described in WO-A 97/08156, WO-A-97/31904, DE-A-19826670, WO-A-98/15536, WO-A-98/15537, WO-A-98/15538, WO-A-98/15539 and also DE-A-19828519, WO-A-98/34925, WO-A-98/42684, WO-A-99/18100, WO-A-99/19309, WO-A-99/37627 and WO-A-99/65882, preferably those of the formula (K) 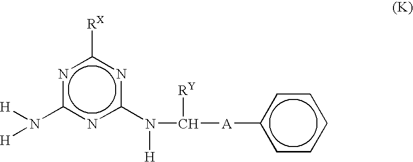
in which
R^{X} is (C₁-C₄)-alkyl or (C₁-C₄)-haloalkyl;
R^{Y} is (C₁-C₄)-alkyl, (C₃-C₆)-cycloalkyl or (C₃-C₆)-cycloalkyl-(C₁-C₄)-alkyl and
A is —CH₂—, —CH₂—CH₂—, —CH₂—CH₂—CH₂—, —O—, —CH₂—CH₂—O—, —CH₂—CH₂—CH₂—O—, particularly preferably those of the formulae K1-K7 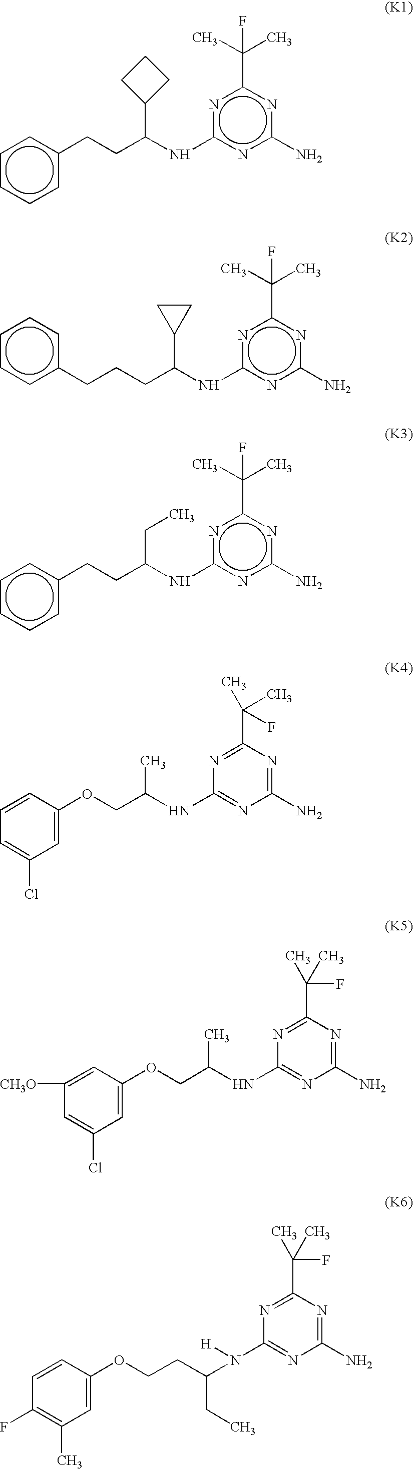 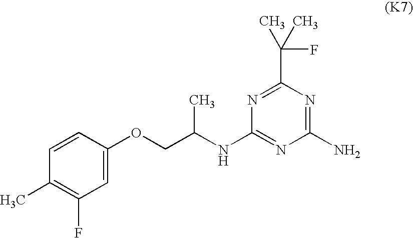
   L) Phosphrous-containing herbicides, for example of the glusosinate type, such as gulfosinate in a narrower sense, i.e. D,L-2-amino-4-[hydrox(methyl)phoshinyl]-butanoic acid, glufosinate monoammonium salt, L-glufosinate, L- or (2S)-2-amino-4-[hydroxy(methyl)Phosphinyl]butanoic acid, L-glufosinate monoammonium salt or bialaphos (or bilanafos), i.e. L2-amino-4-[hydrox(methyl)Phosphinyl]butanoyl-L-alanyl-L-alanine, in particular its sodium salt, or of the glyphosate type, such as glyphosate, i.e. N-(phosphonomethyl)glycine, glyphosate monoisopropylammonium salt, glyphosate sodium salt or sulfosate, i.e. N-(phosphonomethyl)glycine trimesium salt=N-(phosphonomethyl)glycine trimethylsulfoxonium salt.

The herbicides of groups E to L are known, for example, from the abovementioned publications and from “The Pesticide Manual”, 13th edition, 2003, The British Crop Protection Council, “Agricultural Chemicals Book II—Herbicides—”, by W. T. Thompson, Thompson Publications, Fresno Calif., USA 1990 and “Farm Chemicals Handbook '90”, Meister Publishing Company, Willoughby Ohio, USA, 1990.

If the oil suspension concentrates according to the invention comprise agrochemically active compounds e), their proportion by weight is generally from 0.1 to 50% by weight, in particular from 0.5 to 25% by weight.

The total content of active compounds (sum of components a)+c)+d)+e)) contained in the oil suspension concentrates according to the invention is generally between 1 and 80% by weight, in particular between 3 and 60% by weight.

The sulfosuccinates (component f)) optionally contained in the oil suspension concentrates according to the invention can, for example, be mono- or diesters of sulfosuccinic acid, preferably those of the formula (III)
R¹—(X₁)ₙ—O—CO—CH₂—CH(SO₃M)—CO—O—(X₂)ₘ—R² (III)
in which
R¹ is H or an unsubstituted or substituted C₁-C₃₀-hydrocarbon radical, such as C₁-C₃₀-alkyl or C₇-C₃₀-alkylaryl,
R² is H or an unsubstituted or substituted C₁-C₃₀-hydrocarbon radical, such as C₁-C₃₀-alkyl or C₇-C₃₀-alkylaryl, or a cation, for example a metal cation, such as an alkali metal or alkaline earth metal cation, or an ammonium cation, such as NH₄ or an alkyl-, alkylaryl- or poly(arylalkyl)-phenylammonium cation,
X¹, X² are identical or different and independently of one another are a spacer unit, such as a polyether unit or a polyester unit,
n, m are identical or different and independently of one another are zero or 1, preferably zero, and
M is a cation, for example a metal cation, such as an alkali metal or alkaline earth metal cation, or an ammonium cation, such as NH₄ or an alkyl-, alkylaryl- or poly(arylalkyl)phenylammonium cation.

Preference is given to sulfosuccinates of the formula (III) in which R¹ and R² are identical or different and independently of one another are linear, branched or cyclic, saturated or unsaturated C₁-C₂₀-, preferably C₄-C₁₈-, alkyl radicals, such as methyl, ethyl, butyl, hexyl, cyclohexyl, octyl, such as 2-ethylhexyl, decyl, tridecyl or octadecyl radicals, or R¹ and R² are C₇-C₂₀-alkylaryl radicals, such as nonylphenyl, 2,4,6-tri-sec-butylphenyl, 2,4,6-tris-(1-phenylethyl)phenyl, alkylbenzyl or a hydrocinnamic radical,

X₁ and X₂ are identical or different and independently of one another are polyether units, such as polyethylene glycols —(C₂H₄O)ₚ— or polypropylene glycols —(C₃H₆O)ₚ— where p=1 to p=20, in particular p=1 to p=12, or polyester units, such as polyhydroxybutyric acid —(CH[CH₃]—CH₂—COO)_{q}— or polylactic acid —(CH[CH₃]—COO)_{q}— where q=1 to q=15, in particular q=1 to q=8,

n, m are identical or different and independently of one another are zero or 1, preferably zero, and M is a cation, for example a metal cation, such as an alkali metal or alkaline earth metal cation, or an ammonium cation which may be alkyl-substituted.

Examples of sulfosuccinates according to the invention are
a1) sulfosuccinate which is esterified once or twice with linear, cyclic or branched aliphatic, cycloaliphatic and/or aromatic alcohols, having, for example, 1 to 22 carbon atoms in the alkyl radical, preferably mono- or dialkali metal sulfosuccinate, in particular mono- or disodium sulfosuccinate, which is esterified once or twice with methanol, ethanol, (iso)propanol, (iso)butanol, (iso)pentanol, (iso)hexanol, cyclohexanol, (iso)heptanol, (iso)octanol (in particular: ethylhexanol), (iso)nonanol, (iso)decanol, (iso)undecanol, (iso)dodecanol or (iso)tridecanol,
a2) sulfosuccinate which is esterified once or twice with (poly)alkylene oxide adducts of alcohols, having, for example, 1 to 22 carbon atoms in the alkyl radical and 1 to 200, preferably 2 to 200, alkylene oxide units in the (poly)alkylene oxide moiety, preferably mono- or dialkali metal sulfosuccinate, in particular mono- or disodium sulfosuccinate, which is esterified once or twice with dodecyl/tetradecyl alcohol ⊕ 2-5 mol of ethylene oxide or with i-tridecyl+3 mol of ethylene oxide,
a3) the dialkali metal salt, preferably the disodium salt, of maleic anhydride which has been reacted with one equivalent of an amine or an amino-terminated (poly)alkylene oxide adduct of an alcohol, an amine, a fatty acid, an ester or an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of coconut fatty amine and then sulfonated,
a4) the dialkali metal salt, preferably the disodium salt, of maleic anhydride which has been reacted with one equivalent of an amide or a (poly)alklene oxide adduct of an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of oleylamide+2 mol of ethylene oxide and then sulfonated, and/or
a5) the tetraalkali metal salt, preferably the tetrasodium salt, of N-(1,2-dicarboxy-ethyl)-N-octadecylsulfo-succinamate.

Examples of sulfosuccinates of groups a1) to a5) which are commercially available and preferred within the context of the present invention are listed below:
a1) sodium dialkylsulfosuccinate, for example sodium di-(C₄-C₁₈)-alkylsulfosuccinate, such as sodium diisooctylsulfosuccinate, preferably sodium di(2-ethylhexyl)sulfosuccinate, commercially available, for example, in the form of the Aerosol® brands (Cytec), the Agrilan® or Lankropol® brands (Akzo Nobel), the Empimin® brands (Albright&Wilson), the Cropol® brands (Croda), the Lutensit® brands (BASF), the Triton® brands (Union Carbide), the Geropon® brands (Rhodia) or the Imbirol®, Madeol® or Polirol® brands (Cesalpinia),
a2) sodium alcohol polyethylene glycol ether sulfosuccinate, commercially available, for example, in the form of Geropone® ACR brands (Rhodia),
a3) disodium alcohol polyethylene glycol ether semisulfosuccinate, commercially available, for example, in the form of the Aerosol® brands (Cytec), the Marlinat® or Sermul® brands (Condea), the Empicol® brands (Albright&Wilson), the Secosol® brands (Stepan), the Geropone® brands (Rhodia), the Disponil® or Texapon® brands (Cognis) or the Rolpone® brands (Cesalpinia),
a4) disodium N-alkylsulfosuccinamate, commercially available, for example, in the form of the Aerosol® brands (Cytec), the Rewopol® or Rewoderm® brands (Rewo), the Empimin® brands (Albright&Wilson), the Geropon® brands (Rhodia) or the Polirol® brands (Cesalpinia),
a5) disodium fatty acid amide polyethylene glycol ether semisulfosuccinate, commercially available, for example, in the form of the Elfanol® or Lankropol® brands (Akzo Nobel), the Rewoderm®, Rewocid® or Rewopol® brands (Rewo), the Emcol® brands (Witco), the Standapol® brands (Cognis) or the Rolpon® brands (Cesalpinia), and
a6) tetrasodium N-(1,2-dicarboxyethyl)-N-octadecylsulfosuccinamate, commercially available, for example, in the form of Aerosol 22® (Cytec).

Sulfosuccinates are commercially available, for example, as AEROSOL® (CYTEC), AGRILAN® or LANKROPOL® (AKZO NOBEL), EMPIMIN® (HUNTSMAN), CROPOL® (CRODA), LUTENSIT® (BASF), TRITON® GR series (UNIONCARBIDE), IMBIROL®/MADEOL®/POLIROL® (CESALPINIA); as GEROPON®AR series or as GEROPON® SDS (RHODIA).

Preferred sulfosuccinates are, for example, the sodium, potassium and ammonium salts of bis(alkyl)sulfosuccinates, where the alkyl radicals are identical or different and contain 4 to 16 carbon atoms and are, for example, butyl, hexyl, octyl, such as 2-ethylhexyl, or decyl radicals, which may be straight-chain or branched. Particular preference is given to alkali metal di(octyl)sulfosuccinates such as sodium di(2-ethylhexyl)sulfosuccinate.

If the oil suspension concentrates according to the invention comprise sulfosuccinates, their proportion by weight is generally 0.1-60% by weight, in particular 1-35% by weight.

Customary auxiliaries and additives (component g)) which may also be contained in the oil suspension concentrates according to the invention are, for example: surfactants, such as emulsifiers and dispersants, thickeners and thixotropic agents, adjuvants, wetting agents, anti-drift agents, adhesives, penetrants, preservatives and antifreeze agents, stabilizers, antioxidants, solubilizers, fillers, carriers and colorants, antifoams, fertilizers, evaporation inhibitors and agents which modify pH and viscosity.

Suitable emulsifiers and dispersants are, for example, nonionic emulsifiers and dispersants, for example:
1) polyalkoxylated, preferably polyethoxylated, saturated and unsaturated aliphatic alcohols,
having 8 to 24 carbon atoms in the alkyl radical, which is derived from the corresponding fatty acids or from petrochemical products, and
having 1 to 100, preferably 2 to 50, ethylene oxide units (EO), it being possible for the free hydroxyl group to be alkoxylated,
which are commercially available, for example as Genapol® X and Genapol® O series (Clariant), Crovol® M series (Croda) or as Lutensol® series (BASF), or are obtainable therefrom by etherification, for example Genapol®X060 methyl ether,
2) polyalkoxylated, preferably polyethoxylated, arylalkylphenols, such as, for example, 2,4,6-tris(1-phenylethyl)phenol (tristyrylphenol) having an average degree of ethoxylation of between 10 and 80, preferably from 16 to 40, such as, for example SOPROPHOR® BSU (RHODIA) or HOE S 3474 (CLARIANT),
3) polyalkoxylated, preferably polyethoxylated, alkylphenols having one or more alkyl radicals, such as, for example, nonylphenol or tri-sec-butylphenol, and a degree of ethoxylation of between 2 and 40, preferably from 4 to 15, such as, for example, ARKOPAL® N series or SAPOGENAT® T series (CLARIANT),
4) polyalkoxylated, preferably polyethoxylated, hydroxyfatty acids or glycerides which contain hydroxyfatty acids, such as, for example, ricinine or castor oil, having a degree of ethoxylation of between 10 and 80, preferably from 25 to 40, such as, for example, the EMULSOGEN® EL series (CLARIANT) or the AGNIQUE® CSO series (COGNIS),
5) polyalkoxylated, preferably polyethoxylated, sorbitan esters, such as, for example, Atpluse® 309 F (UNIQEMA) or the Alkamuls® series (Rhodia),
6) di- and tri-block copolymers, for example from alkylene oxides, for example from ethylene oxide and propylene oxide, having average molar masses between 200 and 10 000, preferably from 1000 to 4000, g/mol, the proportion by mass of the polyethoxylated block varying between 10 and 80%, such as, for example, the GENAPOL® PF series (CLARIANT), the PLURONIC® series (BASF), or the SYNPERONIC® PE series (UNIQEMA).

Preferred nonionic emulsifiers and dispersants are, for example, polyethoxylated alcohols, polyethoxylated triglycerides which contain hydroxyfatty acids and polyethylene oxide/polypropylene oxide block copolymers.

The total proportion of nonionic emulsifiers and dispersants in the oil suspension concentrates according to the invention is generally between 0 and 40% by weight, preferably between 1 and 30% by weight. If nonionic emulsifiers and dispersants are, in addition to their emulsifying/dispersing properties, also used for increasing the biological effectiveness, for example as penetrants or adhesives, their proportion in the oil suspension concentrates according to the invention can be increased to up to 60% by weight.

Also suitable are ionic emulsifiers and dispersants, for example:
1) polyalkoxylated, preferably polyethoxylated, emulsifiers/dispersants (cf. component e) which are ionically modified, for example by conversion of the terminal free hydroxyl function of the polyethylene oxide block into a sulfate or phosphate ester (for example as alkali metal and alkaline earth metal salts), such as, for example, Genapole LRO or dispersant 3618 (Clariant), Emulphoro (BASF) or Crafol® AP (Cognis),
2) alkali metal and alkaline earth metal salts of alkylarylsulfonic acids having a straight-chain or branched alkyl chain, such as phenylsulfonate CA or phenylsulfonate CAL (Clariant), Atlox® 3377BM (ICI), or the Empiphose TM series (Huntsman),
3) polyelectrolytes, such as lignosulfonates, condensates of naphthalenesulfonate and formaldehyde, polystyrenesulfonate or sulfonated unsaturated or aromatic polymers (polystyrenes, polybutadienes or polyterpenes), such as the Tamole series (BASF), Morwet® D425 (Witco), the Kraftsperse® series (Westvaco) or the Borresperse® series (Borregard).

Preferred ionic emulsifiers/dispersants are, for example, salts of alkylarylsulfonic acids and polyelectrolytes from the polycondensation of naphthalenesulfonate and formaldehyde.

The total proportion of ionic emulsifiers and dispersants in the oil suspension concentrates according to the invention is generally between 0 and 20% by weight, in particular between 0 and 8% by weight.

Suitable thickeners and thixotropic agents are, for example:
1) modified natural silicates, such as chemically modified bentonites, hectorites, attapulgites, montmorillonites, smectites or other silicate minerals, such as BENTONE® (ELEMENTIS), ATTAGEL® (ENGELHARD), AGSORB® (OIL-DRI CORPORATION) or HECTORITE® (AKZO NOBEL),
2) synthetic silicates, such as silicates of the SIPERNAT®, AEROSIL® or DUROSIL® series (DEGUSSA), the CAB-O-SIL® series (CABOT) or the VAN GEL series (R. T. VANDERBILT),
3) thickeners based on synthetic polymers, such as thickeners of the Thixin® or THIXATROL® series (ELEMENTIS),
4) thickeners based on natural polymers and natural oils, for example from the THIXIN® or THIXATROL® series (ELEMENTIS).

Preferred thickeners and thixotropic agents are, for example, modified phyllosilicates and thickeners based on synthetic polymers.

The proportion of thickeners and thixotropic agents in the oil suspension concentrates according to the invention is generally between 0 and 5% by weight, in particular between 0.2 and 4% by weight.

Suitable adjuvants are, for example, fatty acid esters, for example of natural origin, for example natural oils, such as animal oils or vegetable oils, or of synthetic origin, for example the Edenor® series, for example Edenor® MEPa or Edenor® MESU, or the AGNIQUE® ME series or AGNIQUE® AE series (COGNIS), the SALIM® ME series (SALIM), the Radia® series, for example Radia® 30167 (ICI), the Prilube® series, for example Prilubeo® 1530 (Petrofina), the STEPAN® C series (STEPAN) or the WITCONOL® 23 series (WITCO). The fatty acid esters are preferably esters of C₁₀-C₂₂-, with preference C₁₂-C₂₀-, fatty acids. The C₁₀-C₂₂-fatty acid esters are, for example, esters of unsaturated or saturated C₁₀-C₂₂-fatty acids, in particular those having an even number of carbons, for example erucic acid, lauric acid, palmitic acid, and in particular C18-fatty acids, such as stearic acid, oleic acid, linoleic acid or linolenic acid.

Examples of fatty acid esters such as C₁₀-C₂₂-fatty acid esters are glycerol and glycol esters of fatty acids such as C₁₀-C₂₂-fatty acids, or transesterification products thereof, for example fatty acid alkyl esters such as C₁₀-C₂₂-fatty acid C₁-C₂₀-alkyl esters, which can be obtained, for example, by transesterification of the abovementioned glycerol or glycol fatty acid esters such as C₁₀-C₂₂-fatty acid esters with C₁-C₂₀-alcohols (for example methanol, ethanol, propanol or butanol). The transesterification can be carried out by known methods, as described, for example, in Römpp Chemie Lexikon, 9th edition, volume 2, page 1343, Thieme Verlag Stuttgart.

Preferred fatty acid alkyl esters such as C₁₀-C₂₂-fatty acid C₁-C₂₀-alkyl esters are methyl esters, ethyl esters, propyl esters, butyl esters, 2-ethylhexyl esters and dodecyl esters. Preferred glycol and glycerol fatty esters such as C₁₀-C₂₂-fatty acid esters are the uniform or mixed glycol esters and glycerol esters of C₁₀-C₂₂-fatty acids, in particular of such fatty acids having an even number of carbon atoms, for example erucic acid, lauric acid, palmitic acid and in particular C₁₈-fatty acids such as stearic acid, oleic acid, linoleic acid or linolenic acid.

Animal oils b) are generally known and commercially available. For the purpose of the present invention, the term “animal oils” is to be understood as meaning, for example, oils of animal origin such as whale oil, cod-liver oil, musk oil or mink oil.

Vegetable oils b) are generally known and commercially available. For the purpose of the present invention, the term “vegetable oils” is to be understood as meaning, for example, oils of oleaginous plant species, such as soybean oil, rapeseed oil, corn oil, sunflower oil, cottonseed oil, linseed oil, coconut oil, palm oil, thistle oil, walnut oil, arachis oil, olive oil or castor oil, in particular rapeseed oil, where the vegetable oils also include their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fatty acids having, in particular, an even number of carbon atoms, for example erucic acid, lauric acid, palmitic acid and in particular, C₁₈-fatty acids such as stearic acid, oleic acid, linoleic acid or linolenic acid.

Examples of vegetable oils are C₁₀-C₂₂-fatty acid esters of glycerol or glycol with C₁₀-C₂₂-fatty acids, or C₁₀-C₂₂-fatty acid C₁-C₂₀-alkyl esters which can be obtained, for example, by transesterification of the glycerol or glycol C₁₀-C₂₂-fatty acid esters mentioned above with C₁-C₂₀-alcohols (for example methanol, ethanol, propanol or butanol). The transesterification can be carried out by known methods as described, for example, in Römpp Chemie Lexikon, 9th edition, volume 2, page 1343, Thieme Verlag Stuttgart.

The vegetable oils can be contained in the oil suspension concentrates according to the invention for example in the form of commercially available vegetable oils, in particular rapeseed oils, such as rapeseed oil methyl ester, for example Phytorob® B (Novance, France), Edenor® MESU and the Agnique® ME series (Cognis, Germany), the Radia® series (ICI), the Prilubeo series (Petrofina), or biodiesel or in the form of commercially available, plant-oil-containing formulation additives, in particular those based on rapeseed oils, such as rapeseed oil methyl esters, for example Hasten® (Victorian Chemical Company, Australia, hereinbelow referred to as Hasten, main ingredient: rapeseed oil ethyl ester), Actirob® B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

Examples of synthetic fatty acid esters are, for example, those derived from fatty acids having an odd number of carbon atoms, such as C₁₁-C₂₁-fatty acid esters.

The proportion of adjuvants such as fatty acid esters in the oil suspension concentrates according to the invention is generally between 0 and 20% by weight, preferably between 0.5 and 15% by weight.

Preference is given to oil suspension concentrates according to the invention comprising:
a) 1 to 60% by weight of diflufenican,
b) 5 to 90% by weight of one or more hydrocarbons,
c) 0 to 30% by weight, preferably 0.01 to 30% by weight, of one or more herbicidally active compounds from the group of the ALS inhibitors, preferably the sulfonamides,
d) 0 to 40% by weight, preferably 0.1 to 40% by weight, of one or more safeners,
e) 0 to 25% by weight of one or more agrochemically active compounds different from a), c) and d),
f) 0 to 35% by weight, preferably 0.1 to 35% by weight, of one or more sulfosuccinates,
g) 0 to 60% by weight, preferably 1 to 60% by weight, of other auxiliaries and additives, in particular 0 to 30% by weight of one or more nonionic emulsifiers and dispersants, 0 to 8% by weight of one or more ionic emulsifiers and dispersants, 0 to 4% by weight of one or more thickeners or thixotriopic agents, and 0-20% by weight of adjuvants, such as fatty acid esters.

In a preferred embodiment, the oil suspension concentrate according to the invention comprises
a) 1 to 30% by weight of diflufenican,
b) 5 to 90% by weight of one or more aliphatic hydrocarbons, preferably C₅-C₁₆-alkanes,
c) 0.01 to 30% by weight of one or more herbicidally active compounds of the formula (I) and/or salts thereof, preferably A1, A2, A3, A4, A5, A6, A7, A8, A9, A10, A11, A12, A13 and/or A14,
d) 0.1 to 20% by weight of a safener from the group consisting of S1-1, S1-9 and S2-1,
e) 0 to 25% by weight of one or more agrochemically active compounds different from a), c) and d),
f) 0.1 to 30% by weight of one or more sulfosuccinates, preferably di(C₁-C₂₂)-alkylsulfosuccinates,
g) 0.5 to 50% by weight of other auxiliaries and additives, in particular 0 to 30% by weight of one or more nonionic emulsifiers and dispersants, 0 to 8% by weight of one or more ionic emulsifiers and dispersants, 0 to 4% by weight of one or more thickeners and thixotropic agents, and 0.5-15% by weight of adjuvants, such as fatty acid esters.

Oil suspension concentrates according to the invention comprising the components listed below may be mentioned as particularly preferred examples; however, this is not meant to be a limitation. Here, Bayol is a solvent from the Bayol® series, preferably Bayol®82.

diflufenican+Bayol, diflufenican+Bayol+A1, diflufenican+Bayol+A2, diflufenican+Bayol+A3, diflufenican+Bayol+A4, diflufenican+Bayol+A5, diflufenican+Bayol+A6, diflufenican+Bayol+A7, diflufenican+Bayol+A8, diflufenican+Bayol+A9, diflufenican+Bayol+A10, diflufenican+Bayol+A11, diflufenican+Bayol+A12, diflufenican+Bayol+A13, diflufenican+Bayol+A14, diflufenican+Bayol+rapeseed oil methyl ester;

diflufenican+Bayol+A1+S1-1, diflufenican+Bayol+A2+S1-1, diflufenican+Bayol+A3+S1-1, diflufenican+Bayol+A4+S1-1, diflufenican+Bayol+A5+S1-1, diflufenican+Bayol+A6+S1-1, diflufenican+Bayol+A7+S1-1, diflufenican+Bayol+A8+S1-1, diflufenican+Bayol+A9+S1-1, diflufenican+Bayol+A10+S1-1, diflufenican+Bayol+A11+S1-1, diflufenican+Bayol+A12+S1-1, diflufenican+Bayol+A13+S1-1, diflufenican+Bayol+A14+S1-1, diflufenican+Bayol+A1+S1-9, diflufenican+Bayol+A2+S1-9, diflufenican+Bayol+A3+S1-9, diflufenican+Bayol+A4+S1-9, diflufenican+Bayol+A5+S1-9, diflufenican+Bayol+A6+S1-9, diflufenican+Bayol+A7+S1-9, diflufenican+Bayol+A7+S1-9, diflufenican+Bayol+A8+S1-9, diflufenican+Bayol+A9+S1-9, diflufenican+Bayol+A10+S1-9, diflufenican+Bayol+A11+S1-9, diflufenican+Bayol+A12+S1-9, diflufenican+Bayol+A13+S1-9, diflufenican+Bayol+A14+S1-9, diflufenican+Bayol+A1+S2-1, diflufenican+Bayol+A2+S2-1, diflufenican+Bayol+A3+S2-1, diflufenican+Bayol+A4+S2-1, diflufenican+Bayol+A5+S2-1, diflufenican+Bayol+A6+S2-1, diflufenican+Bayol+A7+S2-1, diflufenican+Bayol+A8+S2-1, diflufenican+Bayol+A9+S2-1, diflufenican+Bayol+A10+S2-1, diflufenican+Bayol+A11+S2-1, diflufenican+Bayol+A12+S2-1, diflufenican+Bayol+A13+S2-1, diflufenican+Bayol+A14+S2-1;

diflufenican+Bayol+A1+sodium di(2-ethylhexyl)sulfosuccinate, diflufenican+Bayol+A2+sodium di(2-ethylhexyl)sulfosuccinate, diflufenican+Bayol+A3+sodium di(2-ethylhexyl)sulfosuccinate, diflufenican+Bayol+A4+sodium di(2-ethylhexyl)sulfosuccinate, diflufenican+Bayol+A5+sodium di(2-ethylhexyl)sulfosuccinate, diflufenican+Bayol+A6+sodium di(2-ethylhexyl)sulfosuccinate, diflufenican+Bayol+A7+sodium di(2-ethylhexyl)sulfosuccinate, diflufenican+Bayol+A8+sodium di(2-ethylhexyl)sulfosuccinate, diflufenican+Bayol+A9+sodium di(2-ethylhexyl)sulfosuccinate, diflufenican+Bayol+A10+sodium di(2-ethylhexyl)sulfosuccinate, diflufenican+Bayol+A11+sodium di(2-ethylhexyl)sulfosuccinate, diflufenican+Bayol+A12+sodium di(2-ethylhexyl)sulfosuccinate, diflufenican+Bayol+A13+sodium di(2-ethylhexyl)sulfosuccinate, diflufenican+Bayol+A14+sodium di(2-ethylhexyl)sulfosuccinate;

diflufenican+Bayol+A1+S1-1+rapeseed oil methyl ester, diflufenican+Bayol+A2+S1-1+rapeseed oil methyl ester, diflufenican+Bayol+A3+S1-1+rapeseed oil methyl ester, diflufenican+Bayol+A4+S1-1 ⊕ rapeseed oil methyl ester, diflufenican+Bayol+A5+S1-1 ⊕ rapeseed oil methyl ester, diflufenican+Bayol+A6+S1-1 ⊕ rapeseed oil methyl ester, diflufenican+Bayol+A7+S1-1 ⊕ rapeseed oil methyl ester, diflufenican+Bayol+A8+S1-1 ⊕ rapeseed oil methyl ester, diflufenican+Bayol+A9+S1-1 ⊕ rapeseed oil methyl ester, diflufenican+Bayol+A10+S1-1 rapeseed oil methyl ester, diflufenican+Bayol+A11+S1-1 ⊕ rapeseed oil methyl ester, diflufenican+Bayol+A12+S1-1 ⊕ rapeseed oil methyl ester, diflufenican+Bayol+A13+S1-1 ⊕ rapeseed oil methyl ester, diflufenican+Bayol+A14+S1-1 ⊕ rapeseed oil methyl ester, diflufenican+Bayol+A1+S1-9+rapeseed oil methyl ester, diflufenican+Bayol+A2+S-9+rapeseed oil methyl ester, diflufenican+Bayol+A3+S1-9+rapeseed oil methyl ester, diflufenican+Bayol+A4+S1-9+rapeseed oil methyl ester, diflufenican+Bayol+A5+S1-9 ⊕ rapeseed oil methyl ester, diflufenican+Bayol+A6+S1-9+rapeseed oil methyl ester, diflufenican+Bayol+A7+S1-9+rapeseed oil methyl ester, diflufenican+Bayol+A9+S1-9+rapeseed oil methyl ester, diflufenican+Bayol+A8+S1-9+rapeseed oil methyl ester, diflufenican+Bayol+A10+S1-9+rapeseed oil methyl ester, diflufenican+Bayol+A11+S1-9+rapeseed oil methyl ester, diflufenican+Bayol+A12+S1-9+rapeseed oil methyl ester, diflufenican+Bayol+A13+S1-9+rapeseed oil methyl ester, diflufenican+Bayol+A14+S1-9+rapeseed oil methyl ester, diflufenican+Bayol+A1+S2-1+rapeseed oil methyl ester, diflufenican+Bayol+A2+S2-1+rapeseed oil methyl ester, diflufenican+Bayol+A3+S2-1+rapeseed oil methyl ester, diflufenican+Bayol+A4+S2-1+rapeseed oil methyl ester, diflufenican+Bayol+A5+S2-1+rapeseed oil methyl ester, diflufenican+Bayol+A6+S2-1+rapeseed oil methyl ester, diflufenican+Bayol+A7+S2-1+rapeseed oil methyl ester, diflufenican+Bayol+A8+S2-1+rapeseed oil methyl ester, diflufenican+Bayol+A9+S2-1+rapeseed oil methyl ester, diflufenican+Bayol+A10+S2-1+rapeseed oil methyl ester, diflufenican+Bayol+A11+S2-1+rapeseed oil methyl ester, diflufenican+Bayol+A12+S2-1+rapeseed oil methyl ester, diflufenican+Bayol+A13+S2-1+rapeseed oil methyl ester, diflufenican+Bayol+A14+S2-1+rapeseed oil methyl ester;

diflufenican+Bayol+A1+S1-1+sodium di(2-ethylhexyl)sulfosuccinate, diflufenican+Bayol+A2+S1-1+sodium di(2-ethylhexyl)sulfosuccinate, diflufenican+Bayol+A3+S1-1+sodium di(2-ethylhexyl)sulfosuccinate, diflufenican+Bayol+A4+S1-1+sodium di(2-ethylhexyl)sulfosuccinate, diflufenican+Bayol+A5+S1-1+sodium di(2-ethylhexyl)sulfosuccinate, diflufenican+Bayol+A6+S1-1+sodium di(2-ethylhexyl)sulfosuccinate, diflufenican+Bayol+A7+S1-1+sodium di(2-ethylhexyl)sulfosuccinate, diflufenican+Bayol+A8+S1-1+sodium di(2-ethylhexyl)sulfosuccinate, diflufenican+Bayol+A9+S1-1+sodium di(2-ethylhexyl)sulfosuccinate, diflufenican+Bayol+A10+S1-1+sodium di(2-ethylhexyl)sulfosuccinate, diflufenican+Bayol+A11+S1-1+sodium di(2-ethylhexyl)sulfosuccinate, diflufenican+Bayol+A12+S1-1+sodium di(2-ethylhexyl)sulfosuccinate, diflufenican+Bayol+A13+S1-1+sodium di(2-ethylhexyl)sulfosuccinate, diflufenican+Bayol+A14+S1-1+sodium di(2-ethylhexyl)sulfosuccinate, diflufenican+Bayol+A1+S1-9+sodium di(2-ethylhexyl)sulfosuccinate, diflufenican+Bayol+A2+S1-9+sodium di(2-ethylhexyl)sulfosuccinate, diflufenican+Bayol+A3+S1-9+sodium di(2-ethylhexyl)sulfosuccinate, diflufenican+Bayol+A4+S1-9+sodium di(2-ethylhexyl)sulfosuccinate, diflufenican+Bayol+A5+S1-9+sodium di(2-ethylhexyl)sulfosuccinate, diflufenican+Bayol+A6+S1-9+sodium di(2-ethylhexyl)sulfosuccinate, diflufenican+Bayol+A7+S1-9+sodium di(2-ethylhexyl)sulfosuccinate, diflufenican+Bayol+A8+S1-9+sodium di(2-ethylhexyl)sulfosuccinate, diflufenican+Bayol+A9+S1-9+sodium di(2-ethylhexyl)sulfosuccinate, diflufenican+Bayol+A10+S1-9+sodium di(2-ethylhexyl)sulfosuccinate, diflufenican+Bayol+A11+S1-9+sodium di(2-ethylhexyl)sulfosuccinate, diflufenican+Bayol+A12+S1-9+sodium di(2-ethylhexyl)sulfosuccinate, diflufenican+Bayol+A13+S1-9+sodium di(2-ethylhexyl)sulfosuccinate, diflufenican+Bayol+A14+S1-9+sodium di(2-ethylhexyl)sulfosuccinate, diflufenican+Bayol+A1+S2-1+sodium di(2-ethylhexyl)sulfosuccinate, diflufenican+Bayol+A2+S2-1+sodium di(2-ethylhexyl)sulfosuccinate, diflufenican+Bayol+A3+S2-1+sodium di(2-ethylhexyl)sulfosuccinate, diflufenican+Bayol+A4+S2-1+sodium di(2-ethylhexyl)sulfosuccinate, diflufenican+Bayol+A5+S2-1+sodium di(2-ethylhexyl)sulfosuccinate, diflufenican+Bayol+A6+S2-1+sodium di(2-ethylhexyl)sulfosuccinate, diflufenican+Bayol+A7+S2-1+sodium di(2-ethylhexyl)sulfosuccinate, diflufenican+Bayol+A8+S2-1+sodium di(2-ethylhexyl)sulfosuccinate, diflufenican+Bayol+A9+S2-1+sodium di(2-ethylhexyl)sulfosuccinate, diflufenican+Bayol+A10+S2-1+sodium di(2-ethylhexyl)sulfosuccinate, diflufenican+Bayol+A11+S2-1+sodium di(2-ethylhexyl)sulfosuccinate, diflufenican+Bayol+A12+S2-1+sodium di(2-ethylhexyl)sulfosuccinate, diflufenican+Bayol+A13+S2-1+sodium di(2-ethylhexyl)sulfosuccinate, diflufenican+Bayol+A14+S2-1+sodium di(2-ethylhexyl)sulfosuccinate;

diflufenican+Bayol+A1+S1-1+sodium di(2-ethylhexyl)sulfosuccinate+rapeseed oil methyl ester, diflufenican+Bayol+A2+S1-1+sodium di(2-ethylhexyl)sulfosuccinate+rapeseed oil methyl ester, diflufenican+Bayol+A3+S1-1+sodium di(2-ethylhexyl)sulfosuccinate+rapeseed oil methyl ester, diflufenican+Bayol+A4+S1-1+sodium di(2-ethylhexyl)sulfosuccinate+rapeseed oil methyl ester, diflufenican+Bayol+A5+S1-1+sodium di(2-ethylhexyl)sulfosuccinate+rapeseed oil methyl ester, diflufenican+Bayol+A6+S1-1+sodium di(2-ethylhexyl)sulfosuccinate+rapeseed oil methyl ester, diflufenican+Bayol+A7+S1-1+sodium di(2-ethylhexyl)sulfosuccinate+rapeseed oil methyl ester, diflufenican+Bayol+A8+S1-1+sodium di(2-ethylhexyl)sulfosuccinate+rapeseed oil methyl ester, diflufenican+Bayol+A9+S1-1+sodium di(2-ethylhexyl)sulfosuccinate+rapeseed oil methyl ester, diflufenican+Bayol+A10+S1-1+sodium di(2-ethylhexyl)sulfosuccinate+rapeseed oil methyl ester, diflufenican+Bayol+A11+S1-1+sodium di(2-ethylhexyl)sulfosuccinate+rapeseed oil methyl ester, diflufenican+Bayol+A12+S1-1+sodium di(2-ethylhexyl)sulfosuccinate+rapeseed oil methyl ester, diflufenican+Bayol+A13+S1-1+sodium di(2-ethylhexyl)sulfosuccinate+rapeseed oil methyl ester, diflufenican+Bayol+A14+S1-1+sodium di(2-ethylhexyl)sulfosuccinate+rapeseed oil methyl ester, diflufenican+Bayol+A1+S1-9+sodium di(2-ethylhexyl)sulfosuccinate+rapeseed oil methyl ester, diflufenican+Bayol+A2+S1-9+sodium di(2-ethylhexyl)sulfosuccinate+rapeseed oil methyl ester, diflufenican+Bayol+A3+S1-9+sodium di(2-ethylhexyl)sulfosuccinate+rapeseed oil methyl ester, diflufenican+Bayol+A4+S1-9+sodium di(2-ethylhexyl)sulfosuccinate+rapeseed oil methyl ester, diflufenican+Bayol+A5+S1-9+sodium di(2-ethylhexyl)sulfosuccinate+rapeseed oil methyl ester, diflufenican+Bayol+A6+S1-9+sodium di(2-ethylhexyl)sulfosuccinate+rapeseed oil methyl ester, diflufenican+Bayol+A7+S1-9+sodium di(2-ethylhexyl)sulfosuccinate+rapeseed oil methyl ester, diflufenican+Bayol+A8+S1-9+sodium di(2-ethylhexyl)sulfosuccinate+rapeseed oil methyl ester, diflufenican+Bayol+A9+S1-9+sodium di(2-ethylhexyl)sulfosuccinate+rapeseed oil methyl ester, diflufenican+Bayol+A10+S1-9+sodium di(2-ethylhexyl)sulfosuccinate+rapeseed oil methyl ester, diflufenican+Bayol+A11+S1-9+sodium di(2-ethylhexyl)sulfosuccinate+rapeseed oil methyl ester, diflufenican+Bayol+A12+S1-9+sodium di(2-ethylhexyl)sulfosuccinate+rapeseed oil methyl ester, diflufenican+Bayol+A13+S1-9+sodium di(2-ethylhexyl)sulfosuccinate+rapeseed oil methyl ester, diflufenican+Bayol+A14+S1-9+sodium di(2-ethylhexyl)sulfosuccinate+rapeseed oil methyl ester, diflufenican+Bayol+A1+S2-1+sodium di(2-ethylhexyl)sulfosuccinate+rapeseed oil methyl ester, diflufenican+Bayol+A2+S2-1+sodium di(2-ethylhexyl)sulfosuccinate+rapeseed oil methyl ester, diflufenican+Bayol+A3+S2-1+sodium di(2-ethylhexyl)sulfosuccinate+rapeseed oil methyl ester, diflufenican+Bayol+A4+S2-1+sodium di(2-ethylhexyl)sulfosuccinate+rapeseed oil methyl ester, diflufenican+Bayol+A5+S2-1+sodium di(2-ethylhexyl)sulfosuccinate+rapeseed oil methyl ester, diflufenican+Bayol+A6+S2-1+sodium di(2-ethylhexyl)sulfosuccinate+rapeseed oil methyl ester, diflufenican+Bayol+A7+S2-1+sodium di(2-ethylhexyl)sulfosuccinate+rapeseed oil methyl ester, diflufenican+Bayol+A8+S2-1+sodium di(2-ethylhexyl)sulfosuccinate+rapeseed oil methyl ester, diflufenican+Bayol+A9+S2-1+sodium di(2-ethylhexyl)sulfosuccinate+rapeseed oil methyl ester, diflufenican+Bayol+A10+S2-1+sodium di(2-ethylhexyl)sulfosuccinate+rapeseed oil methyl ester, diflufenican+Bayol+A11+S2-1+sodium di(2-ethylhexyl)sulfosuccinate+rapeseed oil methyl ester, diflufenican+Bayol+A12+S2-1+sodium di(2-ethylhexyl)sulfosuccinate+rapeseed oil methyl ester, diflufenican+Bayol+A13+S2-1+sodium di(2-ethylhexyl)sulfosuccinate+rapeseed oil methyl ester, diflufenican+Bayol+A14+S2-1+sodium di(2-ethylhexyl)sulfosuccinate+rapeseed oil methyl ester.

In the combinations mentioned above, it is also possible to combine a plurality of sulfonamides as component c) and to use these compounds together for controlling harmful plants in plant crops. Thus, in a preferred embodiment, for example, different sulfonamides of the formula (I) and/or salts thereof may be combined with one another as component c), for example
mesosulfuron-methyl+iodosulfuron-methyl,
mesosulfuron-methyl+iodosulfuron-methyl-sodium,
mesosulfuron-methyl+foramsulfuron,
mesosulfuron-methyl+foramsulfuron-sodium,
mesosulfuron-methyl-sodium+iodosulfuron-methyl,
mesosulfuron-methyl-sodium+iodosulfuron-methyl-sodium,
mesosulfuron-methyl-sodium+foramsulfuron,
mesosulfuron-methyl-sodium+foramsulfuron-sodium,
foramsulfuron+iodosulfuron-methyl,
foramsulfuron+iodosulfuron-methyl-sodium,
foramsulfuron-sodium+iodosulfuron-methyl,
foramsulfuron-sodium+iodosulfuron-methyl-sodium,
amidosulfuron+iodosulfuron-methyl,
amidosulfuron+iodosulfuron-methyl-sodium,
amidosulfuron-sodium+iodosulfuron-methyl,
amidosulfuron-sodium+iodosulfuron-methyl-sodium,
ethoxysulfuron+iodosulfuron-methyl,
ethoxysulfuron+iodosulfuron-methyl-sodium,
ethoxysulfuron-sodium+iodosulfuron-methyl,
ethoxysulfuron-sodium+iodosulfuron-methyl-sodium,
propoxycarbazone+mesosulfuron-methyl,
propoxycarbazone+mesosulfuron-methyl-sodium,
propoxycarbazone-sodium+mesosulfuron-methyl,
propoxycarbazone-sodium+mesosulfuron-methyl-sodium,
propoxycarbazone+iodosulfuron-methyl,
propoxycarbazone+iodosulfuron-methyl-sodium,
propoxycarbazone-sodium+iodosulfuron-methyl,
propoxycarbazone-sodium+iodosulfuron-methyl-sodium,
flucarbazone+mesosulfuron-methyl,
flucarbazone+mesosulfuron-methyl-sodium,
flucarbazone-sodium+mesosulfuron-methyl,
flucarbazone-sodium+mesosulfuron-methyl-sodium,
flucarbazone+iodosulfuron-methyl,
flucarbazone+iodosulfuron-methyl-sodium,
flucarbazone-sodium+iodosulfuron-methyl,
flucarbazone-sodium+iodosulfuron-methyl-sodium.

The ALS inhibitors c) and their mixtures, for example the active compound mixtures mentioned above of sulfonamides of the formula (I) and/or their salts, may be combined with one or more safeners, in particular with the safeners mefenpyr-diethyl (S1-1), isoxadifen-ethyl (S1-9) and cloquintocet-mexyl (S2-1).

The oil suspension concentrates according to the invention can be prepared by known processes, for example by mixing the components. Thus, for example, it is possible to initially charge component b) (hydrocarbon) and to add the further components a), d), c), e), f) and/or g). It is also possible, if appropriate, to mix component b) with a thickener prior to the addition of the other components. The resulting oil suspension can then, if appropriate after pregrinding, be subjected to fine grinding.

To prepare the mixtures, it is possible to use customary mixing apparatus which, if required, are thermostatted. For pregrinding, it is possible to use, for example, high-pressure homogenizers or mills operating by the rotor-stator principle, such as Ultraturrax homogenizers, for example those from IKA, or toothed colloid mills, for example from Puck. For fine grinding, it is possible to use, for example, bead mills which operate batch-wise, for example from Drais, or bead mills which operate continuously, for example from Bachofen. The preparation process can be adapted to the properties of the components employed and to technical and safety requirements and to economical considerations, and pregrinding and even fine grinding may be dispensed with, if required.

The components a) to g) used for the preparation may comprise water as a minor component which is also found in the oil suspension concentrates according to the invention. Accordingly, the oil suspension concentrates according to the invention may comprise small amounts of water, in general from 0 to 5% by weight.

For application, the oil suspension concentrates according to the invention may, if required, be diluted in a customary manner using, for example, water, to give, for example, emulsions, suspensions, suspoemulsions or solutions. It may be advantageous to add further agrochemically active compounds (for example tank mix components in the form of appropriate formulations) and/or auxiliaries and additives customary for application, for example self-emulsifying oils, such as vegetable oils or paraffin oils, and/or fertilizers to the spray liquors obtained. Accordingly, the present invention also provides such liquid herbicidal compositions obtainable by diluting the oil suspension concentrates according to the invention.

The herbicidal compositions according to the invention (which hereinbelow in each case also includes the oil suspension concentrates according to the invention) have outstanding herbicidal activity against a broad spectrum of economically important monocotyledonous and dicotyledonous harmful plants. Even perennial weeds which produce shoots from rhizomes, rootstocks or other perennial organs and which are difficult to control are controlled well. In this context, it does not matter whether the substances are applied before sowing, pre-emergence or post-emergence. Specific examples may be mentioned of some representatives of the monocotyledonous and dicotyledonous weed flora which can be controlled by the herbicidal compositions according to the invention, without the enumeration being a restriction to certain species.

Examples of weed species on which the herbicidal compositions act efficiently are, from amongst the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and Bromus spp. such as Bromus catharticus, Bromus secalinus, Bromus erectus, Bromus tectorum and Bromus japonicus, and Cyperus species from the annual group, and, among the perennial species, Agropyron, Cynodon, Imperata and Sorghum and also perennial Cyperus species.

In the case of the dicotyledonous weed species, the spectrum of action extends to species such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The compositions according to the invention also act outstandingly efficiently on harmful plants which are found under the specific cultures in rice, such as, for example, Echinochloa, Sagittaria, Alisma, Eleocharis, Scirpus and Cyperus.

If the herbicidal compositions according to the invention are applied to the soil surface before germination, the weed seedlings are either prevented completely from emerging or else the weeds grow until they have reached the cotyledon stage, but then their growth stops, and, eventually, after three to four weeks have elapsed, they die completely.

If the herbicidal compositions according to the invention are applied post-emergence to the green parts of the plants, growth likewise stops drastically a very short time after the treatment, and the weed plants remain at the growth stage at the point of time of application, or they die completely after a certain time, so that in this manner competition by the weeds, which is harmful to the crop plants, is eliminated very early and in a sustained manner.

The herbicidal compositions according to the invention are distinguished by a rapidly commencing and long-lasting herbicidal action. As a rule, the rainfastness of the active compounds in the herbicidal compositions according to the invention is advantageous. A particular advantage is that the dosages used in the herbicidal compositions and the effective dosages of herbicidal compounds can be adjusted to such a low level that their soil action is optimally low. This does not only allow them to be employed in sensitive crops in the first place, but groundwater contaminations are virtually avoided. The active compound combination according to the invention allows the required application rate of the active compounds to be reduced considerably.

The abovementioned properties and advantages are necessary for weed control practice to keep agricultural crops free from undesired competing plants, and thus to ensure and/or increase yield levels from the qualitative and quantitative angle. These novel compositions markedly exceed the technical state of the art with a view to the properties described.

While the herbicidal compositions according to the invention have an outstanding herbicidal activity against monocotyledonous and dicotyledonous weeds, crop plants of economically important crops, for example dicotyledonous crops such as soya, cotton, oilseed rape, sugar beet, or graminaceous crops such as wheat, barley, rye, oats, millet, rice or corn, are damaged only to a minor extent, if at all. This is why the present compounds are highly suitable for the selective control of undesired plant growth in plantations of agricultural crops or of ornamentals.

In addition, the herbicidal compositions according to the invention have outstanding growth-regulatory properties in crop plants. They engage in the plants' metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without simultaneously destroying the plants. Inhibition of vegetative growth is very important in a large number of monocotyledonous and dicotyledonous crops since lodging can thus be reduced, or prevented completely.

Owing to their herbicidal and plant-growth-regulatory properties, the herbicidal compositions according to the invention can also be employed for controlling harmful plants in crops of genetically modified plants which are known or yet to be developed. As a rule, the recombinant plants are distinguished by specific advantageous characteristics, for example by resistances to certain pesticides, in particular certain herbicides, resistances to plant diseases or the causative organisms of plant diseases such as specific insects or microorganisms such as fungi, bacteria or viruses. Other specific characteristics relate, for example, to the harvested material with regard to quantity, quality, storability, composition and specific constituents. Thus, for example, transgenic plants are known whose starch content is increased, or whose starch quality is altered, or those where the harvested material has a different fatty acid composition.

The use of the compositions according to the invention in economically important transgenic crops of useful plants and ornamentals, for example of graminaceous crops such as wheat, barley, rye, oats, millet, rice and corn, or else crops of sugar beet, cotton, soya, oilseed rape, potatoes, tomatoes, peas and other vegetables, is preferred. Preferably, the compositions according to the invention can be employed as herbicides in crops of useful plants which resist the phytotoxic effects of the herbicides, or have been made to resist these effects by recombinant techniques. When using the herbicidal compositions according to the invention in transgenic crops, effects are frequently observed in addition to the effects against harmful plants to be observed in other crops, which are specific for the application in the transgenic crop in question, for example a modified or specifically widened weed spectrum which can be controlled, modified application rates which may be employed for application, preferably good combining ability with the herbicides to which the transgenic crop is resistant, and an effect on growth and yield level of the transgenic crop plants.

The present invention furthermore also relates to a method for controlling unwanted vegetation (for example harmful plants such as monocotyledonous or dicotyledonous weeds or unwanted crop plants), preferably in crops of plants such as cereals (for example wheat, barley, rye, oats, rice, corn and millet), sugar beet, sugar cane, oilseed rape, cotton and soya, especially preferred in monocotyledonous crops such as cereals, for example wheat, barley, rye, oats, and their hybrids such as triticale, rice, corn and millet, where one or more herbicidal compositions according to the invention are applied to the plants (for example harmful plants), plant parts, seeds of the plants or the area on which the plants grow (for example the area under cultivation).

The plant crops may also be genetically modified or have been obtained by mutation selection; they preferably tolerate acetolactate synthase (ALS) inhibitors.

The oil suspension concentrate of the present invention has excellent chemical stability during preparation and storage and is suitable in particular also for combinations of active compounds having different physicochemical properties. Moreover, the oil suspension concentrate has excellent physical stability, is easy to apply and easy to use and has high biological effectiveness and selectivity.

The example below is meant to illustrate the invention without limiting it.

### EXAMPLE

In a receptacle, 33.3 g of Bayol® 82 were initially charged, and 1.8 g of Bentone® 34 were added. After mixing with an Ultra-Turrax®, 0.2 g of propylene carbonate is added and, using the Ultra-Turrax® at high shear forces, gelled. 6 g of Edenor® MESU were then added and, again with high shear forces, incorporated. Subsequently, 19 g of Triton® GR7ME and 5 g of Emulsogen® EL400 were added and again incoporated using the Ultra-Turrax®. 19.54 g of Genapol® X 060 methyl ether and then preground diflufenican were added a little at a time whilst mixing with the Ultra-Turrax®, until the components were incorporated completely. This gave an oil suspension concentrate which was then processed in a Dynomill® mill at about 3000 rpm and a discharge temperature of 25-30° C. After grinding, the oil suspension concentrate was stirred for another 20 minutes and then filled into containers.

Explanation:

Bentone® 34=modified phyllosilicate, Elementis
Edenor® MESU=rapeseed oil methyl ester, Cognis
Emulsogen® EL400=polyethoxylated castor oil comprising 40 units of ethylene oxide, Clariant
Triton® GR-7M E=di(2-ethylhexyl)sulfosuccinate sodium salt in aromatic solvent, Dow Chemicals
Bayol® 82=paraffin oil (Exxon)
Genapol® X060 methyl ether=isotridecyl alcohol comprising 6 units of ethylene oxide, methyl-capped (Clariant)

1. An oil suspension concentrate, comprising
a) a herbicidally active compound diflufenican, and
b) one or more solvents from the group of the hydrocarbons.

2. The oil suspension concentrate as claimed in claim 1 which comprises, as component b), one or more solvents from the group of the acyclic or cyclic hydrocarbons.

3. The oil suspension concentrate as claimed in claim 1, which additionally comprises
c) one or more herbicidally active compounds from the group of the ALS inhibitors,
d) one or more safeners,
e) one or more agrochemically active compounds different from a), c) and d),
f) one or more sulfosuccinates, and/or
g) customary auxiliaries and additives.

4. The oil suspension concentrate as claimed in claim 1 which comprises, as component c), one or more herbicidally active compounds from the group of the sulfonamides, preferably from the group of the triazolopyrimidinesulfonamides, sulfonylaminocarbonyltriazolinones and sulfonylureas.

5. The oil suspension concentrate as claimed in claim 1 which comprises, as component d), one or more safeners from the group of dichlorophenylpyrazoline-3-carboxylic acid and its esters, 5,5-diphenyl-2-isoxazoline-3-carboxylic acid and its esters and 8-quinolineoxyacetic acid and its esters.

6. The oil suspension concentrate as claimed in claim 1 which comprises, as component f), one or more sulfosuccinates from the group of the mono- and diesters of sulfosuccinic acid.

7. The oil suspension concentrate as claimed in claim 1 which comprises, as a component g), one or more fatty acid esters.

8. A process for preparing an oil suspension concentrate as claimed in claim 1, which comprises mixing and, optionally, grinding the components.

9. A method for controlling harmful vegetation, which comprises applying an effective amount of an oil suspension concentrate as claimed in claim 1 to the plants, to parts of the plants, to seed or to the area on which the plants grow.

10. The use of an oil suspension concentrate as claimed in claim 1 for controlling unwanted vegetation.

11. The use of an oil suspension concentrate as claimed in claim 1 for preparing a herbicidal composition.

12. The use as claimed in claim 11 wherein the herbicidal composition is an emulsion, a suspension, a suspoemulsion or a solution.

13. A liquid herbicidal composition, obtainable by diluting an oil suspension concentrate as claimed in claim 1.

14. The liquid herbicidal composition as claimed in claim 13 wherein the herbicidal composition is an emulsion, a suspension, a suspoemulsion or a solution.

15. A liquid herbicidal composition, comprising
a) the herbicidally active compound diflufenican, and
b) one or more solvents from the group of the hydrocarbons.

16. The liquid herbicidal composition as claimed in claim 15, which additionally comprises
c) one or more herbicidally active compounds from the group of the ALS inhibitors,
d) one or more safeners,
e) one or more agrochemically active compounds different from a), c) and d),
f) one or more sulfosuccinates, and/or
g) customary auxiliaries and additives.

17. The liquid herbicidal composition as claimed in claim 15, which additionally comprises water.

18. A method for controlling unwanted vegetation, which comprises applying an effective amount of the herbicidal composition as claimed in claim 13 to the plants, to parts of the plants, to seed or to the area on which the plants grow.

19. The use of a herbicidal composition as claimed in claim 13 for controlling unwanted vegetation.

20. The oil suspension concentrate as claimed in claim 2, which additionally comprises
c) one or more herbicidally active compounds from the group of the ALS inhibitors,
d) one or more safeners,
e) one or more agrochemically active compounds different from a), c) and d),
f) one or more sulfosuccinates, and/or
g) customary auxiliaries and additives.

21. The oil suspension concentrate as claimed in claim 3 which comprises, as component c), one or more herbicidally active compounds from the group of the sulfonamides, preferably from the group of the triazolopyrimidinesulfonamides, sulfonylaminocarbonyltriazolinones and sulfonylureas.

22. The oil suspension concentrate as claimed in claim 4 which comprises, as component d), one or more safeners from the group of dichlorophenylpyrazoline-3-carboxylic acid and its esters, 5,5-diphenyl-2-isoxazoline-3-carboxylic acid and its esters and 8-quinolineoxyacetic acid and its esters.

23. The oil suspension concentrate as claimed in claim 5 which comprises, as component f), one or more sulfosuccinates from the group of the mono- and diesters of sulfosuccinic acid.

24. The oil suspension concentrate as claimed in claim 6 which comprises, as a component g), one or more fatty acid esters.

25. A process for preparing an oil suspension concentrate as claimed in claim 7, which comprises mixing and, optionally, grinding the components.

26. A method for controlling harmful vegetation, which comprises applying an effective amount of an oil suspension concentrate as claimed in claim 7 to the plants, to parts of the plants, to seed or to the area on which the plants grow.

27. The use of an oil suspension concentrate as claimed in claim 7 for controlling unwanted vegetation.

28. The use of an oil suspension concentrate as claimed in claim 7 for preparing a herbicidal composition.

29. A liquid herbicidal composition, obtainable by diluting an oil suspension concentrate as claimed in claim 7.

30. The liquid herbicidal composition as claimed in claim 16, which additionally comprises water.

31. A method for controlling unwanted vegetation, which comprises applying an effective amount of the herbicidal composition as claimed in claim 17 to the plants, to parts of the plants, to seed or to the area on which the plants grow.

32. The use of a herbicidal composition as claimed in claim 17 for controlling unwanted vegetation.
